(19) United States
(12) Patent Application Publication
(10) Pub. No.: US 2014/0278201 A1
(43) Pub. Date: Sep. 18, 2014

(54) TEMPERATURE MEASUREMENT DEVICE AND TEMPERATURE MEASUREMENT METHOD

(71) Applicant: SEIKO EPSON CORPORATION, Tokyo (JP)

(72) Inventor: Sakiko SHIMIZU, Matsumoto (JP)

(73) Assignee: SEIKO EPSON CORPORATION, Tokyo (JP)

(21) Appl. No.: 14/202,303

(22) Filed: Mar. 10, 2014

(30) Foreign Application Priority Data
Mar. 12, 2013 (JP) 2013-048829

(51) Int. Cl. G01K 13/00

(52) U.S. Cl. CPC G01K 13/002
USPC 702/131

(57) ABSTRACT

A temperature measurement device 100 includes: a first temperature sensor 11 and a second temperature sensor 12 that are provided at different positions in a base portion 100 that is in contact with a measurement subject; and a computation processing unit 300 configured to calculate a temperature of the measurement subject by using temperatures detected by the first temperature sensor 11 and the second temperature sensor 12.

### BACKGROUND

1. Technical Field

The present invention relates to a temperature measurement device or the like that measures the temperature of a subject.

2. Related Art

There are various temperature measurement methods. For example, as measurement methods for obtaining the body temperature of a human body as a measurement subject, a method (JP-A-2003-254836) in which the body temperature is obtained from a temperature measured with a temperature sensor covered with a highly conductive metal cover being brought into direct contact with the surface of the human body such as underarm, a method (JP-A-11-37854) in which the body temperature is obtained by detecting the intensity of infrared rays emitted from the inner ear, and various other methods are known.

However, each measurement method has advantages and disadvantages. For measurement, it is necessary to select a measurement method appropriate to various factors including environmental factors such as a location where measurement is taken, factors relating to a part used for measurement, and factors relating to the state of a living body in the case where the living body is used as a measurement subject. Accordingly, the number of selectable measurement methods needs to be increased so as to enable measurement to be performed in a variety of situations.

### SUMMARY

An advantage of some aspects of the invention is to propose a method for achieving a new method for measuring the temperature of a measurement subject.

A first aspect of the invention for solving the above-described problem relates to a temperature measurement device including: temperature sensors provided at different positions in a base portion that is in contact with a surface of a measurement subject; and a computation processing unit configured to calculate a temperature of the measurement subject at a predetermined measurement area by using temperatures detected by the temperature sensors.

A twelfth aspect of the invention relates to a temperature measurement method for a temperature measurement device including temperature sensors provided at different positions in a base portion that is in contact with a surface of a measurement subject, and a computation processing unit, the temperature measurement method including: detecting temperatures by using the temperature sensors; and calculating a temperature of the measurement subject at a predetermined measurement area by using the temperatures detected by the temperature sensors.

According to the above aspects of the invention, it is possible to achieve a new temperature measurement method for calculating the temperature of a measurement subject at a measurement area by using temperatures detected by the temperature sensors provided at different positions in the base portion that is in contact with the surface of the measurement subject.

According to a second aspect of the invention, the temperature measurement device according to the first aspect of the invention may be configured such that the computation processing unit calculates the temperature at the measurement area by using relative relationship data and the temperatures detected by the temperature sensors, the relative relationship data representing a relative relationship of heat balance characteristics at the measurement area and the positions of the temperature sensors when the base portion is in contact with the surface of the measurement subject.

The relative relationship data is data representing a relative relationship of heat balance characteristics at the measurement area and the positions of the temperature sensors when the base portion is in contact with the surface of the measurement subject. As used herein, the term “heat balance” refers to the balance between incoming heat and outgoing heat, and the term “heat balance characteristics” refers to characteristics of the balance between incoming heat and outgoing heat. According to the second aspect of the invention, it is possible to correctly calculate the temperature of the measurement subject at the measurement area by accurately pre-setting the relative relationship data.

According to a third aspect of the invention, the temperature measurement device according to the second aspect of the invention may be configured such that the temperature sensors are provided at positions that are located within the base portion and have heat balance characteristics different from heat balance characteristics outside the base portion.

According to the third aspect of the invention, the temperature sensors are provided at positions that are located within the base portion and have heat balance characteristics different from those outside the base portion. Providing the temperature sensors at positions that are within the base portion and have heat balance characteristics different from those outside the base portion produces a difference in heat balance characteristics at the positions of the temperature sensors.

According to a fourth aspect of the invention, the temperature measurement device according to any one of the first to third aspects of the invention may be configured such that the base portion includes the temperature sensors at (1) positions spaced apart from a contact surface that is in contact with the surface of the measurement subject and having different thermal conductivity characteristics, (2) positions spaced apart from a side surface other than the contact surface and having different thermal conductivity characteristics, or positions in which (1) and (2) are combined.

According to the fourth aspect of the invention, the base portion includes the temperature sensors at (1) positions spaced apart from a contact surface that is in contact with the surface of the measurement subject and having different thermal conductivity characteristics, or (2) positions spaced apart from a side surface other than the contact surface and having different thermal conductivity characteristics. Accordingly, a difference can be produced in the temperatures detected by the plurality of temperature sensors. In this case, the temperature sensors may be provided at positions in which (1) and (2) are combined.

According to a fifth aspect of the invention, the temperature measurement device according to any one of the first to fourth aspects of the invention may be configured such that the base portion includes a plurality of layers having different thermal conductivity characteristics, and includes the temperature sensors in the layers having different thermal conductivity characteristics.

According to the fifth aspect of the invention, by providing the temperature sensors in the plurality of layers of the base portion having different thermal conductivity characteristics, a difference can be produced in heat balance characteristics between positions of the plurality of temperature sensors.

According to a sixth aspect of the invention, the temperature measurement device according to the second or third aspect of the invention may be configured such that the base portion includes three or more temperature sensors at different positions, and the computation processing unit selects at least two temperature sensors from among the temperature sensors provided in the base portion, and calculates the temperature at the measurement area by using the relative relationship data of the selected combination of temperature sensors and temperatures detected by the selected temperature sensors.

According to the sixth aspect of the invention, at least two temperature sensors are selected from among three or more temperature sensors provided at different positions in the base portion. Then, the temperature of the measurement subject at the measurement area is calculated by using the relative relationship data of heat balance characteristics at the positions of the selected temperature sensors, and the temperatures detected by the selected temperature sensors. With this configuration, it is possible to select temperature sensors suitable for measurement from among the three or more temperature sensors disposed at different positions, and calculate the temperature.

According to a seventh aspect of the invention, the temperature measurement device according to any one of the first to sixth aspects of the invention may be configured such that the computation processing unit calculates the temperature at the measurement area in a steady state based on a plurality of temperatures obtained by performing the calculation at different calculation timings.

According to a thirteenth aspect of the invention, the above-described temperature measurement method according to the twelfth aspect of the invention may be configured to further include calculating the temperature at the measurement area in a steady state based on a plurality of temperatures obtained by performing the calculation at different calculation timings.

For example, when the base portion is brought into contact with the surface of a measurement subject that has been exposed to a cold external environment, the contact portion is prevented from being exposed to the external environment, and thus enters a transition state (unsteady state) in which the internal heat of the measurement subject is transferred to increase the temperature of the contact portion. According to the seventh or thirteenth aspect of the invention, the temperature of the measurement subject at the measurement area can be obtained even in such an unsteady state. Accordingly, the temperature measurement can be finished quickly.

According to an eighth aspect of the invention, the temperature measurement device according to the seventh aspect of the invention may be configured such that the computation processing unit outputs, as an output value, the temperature obtained by the estimation when a temperature of the base portion is in an unsteady state.

According to a fourteenth aspect of the invention, the temperature measurement method according to the thirteenth aspect of the invention may be configured to further include outputting, as an output value, the temperature obtained by the estimation when a temperature of the base portion is in an unsteady state.

According to the eighth or fourteenth aspect of the invention, the estimated temperature is used as the output value in the case of an unsteady state. Accordingly, a more certain temperature can be determined as the output value at an early stage.

According to a ninth aspect of the invention, the temperature measurement device according to the seventh or eighth aspect of the invention may be configured such that the computation processing unit outputs, as an output value, the temperature obtained by the calculation when a temperature of the base portion is in a steady state.

According to a fifteenth aspect of the invention, the temperature measurement method according to the thirteenth or fourteenth aspect of the invention may be configured to further include outputting, as an output value, the temperature obtained by the calculation when a temperature of the base portion is in a steady state.

According to the ninth or fifteenth aspect of the invention, in the case of a steady state, the calculated temperature, not the estimated temperature, is used as the output value.

According to a tenth aspect of the invention, the temperature measurement device according to any one of the first to sixth aspects of the invention may be configured such that the computation processing unit estimates a detected temperature in a steady state based on the detected temperatures at different calculation timings, and calculates the temperature at the measurement area by using the estimated detected temperature.

According to the tenth aspect of the invention, the detected temperature in a steady state is estimated based on the temperatures detected at different calculation timings. It is thereby possible to estimate the detected temperature in the steady state even when the measurement state is in the unsteady state. Accordingly, even when the measurement state is in the unsteady state, the temperature at the measurement area can be calculated with higher accuracy.

According to an eleventh aspect of the invention, the temperature measurement device according to any one of the first to tenth aspects of the invention may be configured such that the computation processing unit changes a time interval for performing the calculation depending on whether the temperature of the base portion is in a steady state or an unsteady state.

According to the eleventh aspect of the invention, the time interval for performing the calculation is changed depending on whether the temperature of the base portion is in the steady state or the unsteady state. For example, if the time interval in the unsteady state is set to be shorter than that in the steady state, temperature measurement can be carried out frequently during the period from the start of measurement until when the steady state is reached, and at the same time, the time interval is long in the steady state, which can contribute to power saving.

### BRIEF DESCRIPTION OF THE DRAWINGS

The invention will be described with reference to the accompanying drawings, wherein like numbers reference like elements.

FIGS. 1A to 1C illustrate the principles of temperature calculation.

FIGS. 2A to 2D illustrate installation positions of temperature sensors.

FIGS. 3A to 3D show examples of configurations of a base portion.

FIG. 4 shows an experimental result.

FIG. 5 is a block diagram showing a schematic configuration of a temperature measurement device.

FIG. 6 shows an example of a data structure of temperature data.

FIG. 7 is a flowchart illustrating a procedure of temperature measurement processing.

FIGS. 8A and 8B illustrate a variation.

FIG. 9 is a flowchart illustrating a procedure of a part of temperature measurement processing according to a variation.

FIG. 10 is a flowchart illustrating a procedure of a part of temperature measurement processing according to a variation.

### DESCRIPTION OF EXEMPLARY EMBODIMENTS

### 1. Principles

The present embodiment will be described by taking an example in which the skin is used as a predetermined measurement area of a measurement subject that is subjected to temperature measurement, and its surface temperature is measured. Also, the present embodiment includes two types of temperature measurement: temperature calculation and temperature estimation. First, the temperature calculation will be described, and thereafter the temperature estimation will be described.

1-1. Principles of Temperature Calculation

FIGS. 1A to 1C are diagrams illustrating the principles of temperature calculation according to the present embodiment. In the present embodiment, as shown in FIG. 1A, the surface temperature of a measurement subject is calculated by bringing a contact surface F of a base portion 100 into contact with a surface K of the measurement subject that is subjected to temperature measurement. Note here that a temperature sensor is not brought into direct contact with the surface K of the measurement subject to measure the surface temperature.

The base portion 100 is made of a predetermined material and has a predetermined structure. Examples of the configuration of the base portion 100 will be described later in detail with reference to the drawings. The base portion 100 includes a plurality of temperature sensors that are arranged at different positions.

In the example shown in FIGS. 1A to 1C, the base portion 100 includes two temperature sensors, namely, a first temperature sensor 11 and a second temperature sensor 12. Hereinafter, the positions of the first temperature sensor 11 and the second temperature sensor 12 will be referred to as a “first detection position P₁” and a “second detection position P₂”, respectively.

The temperature sensors can be any known sensors. Examples of sensors that can be used include chip thermistors, flexible printed circuits on which a thermistor pattern is printed, sensors using a platinum resistance thermometer sensor, and the like. Other examples include sensors using thermocouple elements, P-N junction elements, diodes, and the like. The temperature sensors output electric signals corresponding to temperatures at the detection positions (hereinafter, referred to simply as “temperature detection signals”), and the temperatures detected by the respective temperature sensors are obtained based on the temperature detection signals.

In the present embodiment, the measurement subject is a human body, but it may be an organic object other than the human body such as an animal, or may be an inorganic object such as a furnace, a pipe, or an engine. Also, in the present embodiment, an outer layer portion (surface layer portion or surface) is used as the area of a measurement subject that is subjected to temperature measurement (hereinafter, referred to as a “measurement area P_{S}”). Accordingly, in the present embodiment, a skin temperature T_{S} of a human body is measured.

Also, an arbitrary position in outside surroundings will be referred to as an “arbitrary external position”. The term “outside surroundings” as used herein refers to a measurement environment in which the measurement subject is placed.

It is assumed here that the temperature of the outside surroundings is lower than an internal temperature T_{C} of the human body. Heat moves from a hot region to a cold region. Therefore, in this example, heat flow paths that, for example, start from a heat source position P_{C} within the human body such as the internal temperature and reach an arbitrary external position Pₒᵤₜ can be conceived. To be more specific, three heat flow paths can be conceived: a heat flow path (hereinafter, referred to as a “first heat flow path”) starting from the heat source position P_{C}, passing through the first detection position P₁ of the first temperature sensor 11, and reaching the arbitrary external position Pₒᵤₜ; a heat flow path (hereinafter, referred to as a “second heat flow path”) starting from the heat source position P_{C}, passing through the second detection position P₂ of the second temperature sensor 12, and reaching the arbitrary external position Pₒᵤₜ; and a heat flow path (hereinafter, referred to as a “third heat flow path”) starting from the heat source position P_{C}, passing through the measurement area P_{S}, and reaching the arbitrary external position Pₒᵤₜ.

When heat flows through the first to third heat flow paths, the heat is affected by incoming heat flowing from the outside surroundings and outgoing heat flowing to the outside surroundings. In the present embodiment, such heat exchange will be referred to as a “heat balance”. A heat flow path model as shown in FIG. 1B can be obtained by electronic circuit-modeling the above-described heat flow paths by taking into consideration the heat balance.

In the heat flow path model shown in FIG. 1B, various paths can be conceived as paths extending from the heat source position P_{C} to the first detection position P₁. Also various paths can be conceived as paths extending from the first detection position P₁ to the arbitrary external position Pₒᵤₜ. In the heat flow path model shown in FIG. 1B, each path is represented as a resistor. The same applies to the second heat flow path and the third heat flow path. Of course, the value of each thermal resistor is unknown.

FIG. 1C shows a simplified version of the heat flow path model shown in FIG. 1C. A thermal resistor provided between the heat source position P_{C} and the first detection position P₁, and a thermal resistor provided between the first detection position P₁ and the arbitrary external position Pₒᵤₜ are indicated by Rₐ₁ and Rₐ₂, respectively. A thermal resistor provided between the heat source position P_{C} and the second detection position P₂, and a thermal resistor provided between the second detection position P₂ and the arbitrary external position Pₒᵤₜ are indicated by R_{b1} and R_{b2}, respectively. A thermal resistor provided between the heat source position P_{C} and the measurement area P_{S}, and a thermal resistor provided between the measurement area P_{S} and the arbitrary external position Pₒᵤₜ are indicated by RS₁ and RS₂, respectively.

Also, the temperature of the arbitrary external position Pₒᵤₜ will be referred to as an “outside surroundings temperature” and is indicated by Tₒᵤₜ. Also, the temperatures detected by the first temperature sensor 11 and the second temperature sensor 12 will be referred to as a “first detected temperature” and a “second detected temperature”, and are indicated by Tₐ and T_{b}, respectively.

In the heat flow path model, the first detected temperature Tₐ can be expressed by Equation (1) given below by using the thermal resistors Rₐ₁ and Rₐ₂, the internal temperature T_{C}, and the outside surroundings temperature Tₒᵤₜ. The second detected temperature T_{b} can be expressed by Equation (2) given below by using the thermal resistors R_{b1} and R_{b2}, the internal temperature T_{C}, and the outside surroundings temperature Tₒᵤₜ. The skin temperature T_{S} can be expressed by Equation (3) given below by using the thermal resistors R_{S1} and R_{S2}, the internal temperature T_{C}, and the outside surroundings temperature Tₒᵤₜ.

Tₐ=Rₐ₂×T_{C}/(Rₐ₁+Rₐ₂)+Rₐ₁×Tₒᵤₜ/(Rₐ₁+Rₐ₂) (1)

T_{b}=R_{b2}×T_{C}/(R_{b1}+R_{b2})+R_{b1}×Tₒᵤₜ/(R_{b1}+R_{b2}) (2)

T_{S}=R_{S2}×T_{C}/(R_{S1}+R_{S2})+R_{S1}×Tₒᵤₜ/(R_{S1}+R_{S2}) (3)

The coefficients of the outside surroundings temperature Tₒᵤₜ in Equations (1) to (3) are replaced by the following Equations (4) to (6), respectively.

a=Rₐ₁/(Rₐ₁+Rₐ₂) (4)

b=R_{b1}/(R_{b1}+R_{b2}) (5)

S=R_{S1}/(R_{S2}+R_{S2}) (6)

The coefficient a is represented as the percentage of thermal resistance Rₐ₁ in the whole thermal resistance of the first heat flow path. This indicates the influence of heat balance caused by the thermal resistance Rₐ₁ on the heat flow flowing through the first heat flow path, and can be considered as a coefficient representing heat balance characteristics at the first detection position P₁. The same applies to the coefficient b and the coefficient S.

Equations (1) to (3) can be rewritten as the following Equations (7) to (9) by using the coefficients a, b and S.

Tₐ=(1−a)×T_{c}+a×Tₒᵤₜ (7)

T_{b}=(1−b)×T_{c}+b×Tₒᵤₜ (8)

T_{S}=(1−S)×T_{c}+S×Tₒᵤₜ (9)

Furthermore, the outside surroundings temperature Tₒᵤₜ is removed from Equations (7) and (9) so as to give the internal temperature T_{C}, and Equation (10) is thereby obtained. Equation (11) is obtained in the same manner from Equations (8) and (9).

T_{C}=S×Tₐ/(S−a)−a×T_{S}/(S−a) (10)

T_{C}=S×T_{b}/(S−b)−b×T_{S}/(S−b) (11)

If the internal temperature T_{C} is removed from Equations (10) and (11) so as to give the skin temperature T_{S}, Equation (12) is obtained.

{−(S−a)+(S−b)}×T_{S}=(S−b)×Tₐ−(S−a)×T_{b} (12)

Here, as a relationship between the coefficients a, b and S, a heat balance relative coefficient D represented by the following Equation (13) is introduced.

D=(S−a)/(S−b) (13)

The heat balance relative coefficient D is data (coefficient) representing a relative relationship of heat balance characteristics at each of the first detection position P₁, the second detection position P₂, and the measurement area P_{S}. At this time, Equation (12) can be rewritten as Equation (14) by using the heat balance relative coefficient D.

Tₛ=Tₐ/(1−D)−D×T_{b}/(1−D) (14)

In Equation (14), the first detected temperature Tₐ and the second detected temperature T_{b} are temperatures detected by the first temperature sensor 11 and the second temperature sensor 12, respectively. The skin temperature T_{S} can be detected by another arbitrary method, but the values of the thermal resistances Rₐ₁ and Rₐ₂ of the first heat flow path, the values of the thermal resistances R_{b1} and R_{b2} of the second heat flow path, and the values of the thermal resistances R_{S1} and R_{S2} of the third heat flow path are unknown, and thus the value of the heat balance relative coefficient D is also unknown. Accordingly, in the present embodiment, the value of the heat balance relative coefficient D is determined in the following manner.

To be specific, Equation (14) is solved so as to give the heat balance relative coefficient D, and the following Equation (15) is thereby obtained.

D=(Tₐ−T_{S})/(T_{b}−T_{S}) (15)

As can be seen from Equation (15), the heat balance relative coefficient D is the ratio between a difference between the skin temperature T_{S} and the first detected temperature Tₐ and a difference between the skin temperature T_{S} and the second detected temperature T_{b}. Where the skin temperature T_{S} measured by another arbitrary method is defined as a reference skin temperature T_{SO}, and the first detected temperature Tₐ and the second detected temperature T_{b} at the time of measuring the reference skin temperature T_{SO} are respectively defined as a reference first detected temperature T_{aO} and a reference second detected temperature T_{bO}, the heat balance relative coefficient D can be calculated by the following Equation (16).

D=(T_{aO}−T_{SO})/(T_{bO}−T_{SO}) (16)

The value of the heat balance relative coefficient D calculated by Equation (16) is stored. Then, after that, the first detected temperature Tₐ and the second detected temperature T_{b} are continuously detected, and the skin temperature T_{S} is continuously calculated by Equation (14) by using the heat balance relative coefficient D and the first detected temperature Tₐ and the second detected temperature T_{b} that have been detected. In this way, the temperature calculation is performed.

1-2. Installation Positions of Temperature Sensors

Installation positions of the temperature sensors will be described with reference to FIGS. 2A to 2D. Basically, it is sufficient that the first temperature sensor 11 and the second temperature sensor 12 are installed in, for example, any two different locations within the base portion 100 as shown in FIG. 2A. Because it is physically impossible to install two different temperature sensors at the same installation position, the temperatures detected by the first temperature sensor 11 and the second temperature sensor 12 should basically be different. In other words, there should be a difference between the temperature detected by the first temperature sensor 11 and the temperature detected by the second temperature sensor 12, although the difference may be very small. Accordingly, the surface temperature of the measurement subject can be calculated in accordance with the above-described principles. This implies that the first temperature sensor 11 and the second temperature sensor 12 are provided at positions that are located within the base portion 100 and have heat balance characteristics different from those outside the base portion 100.

That is, when heat flow paths extending from the heat source to the outside surroundings are assumed, the first temperature sensor 11 and the second temperature sensor 12 are installed at positions spaced apart from the heat source and having different thermal conductivity characteristics. The term “thermal conductivity characteristics” as used herein refers to characteristics of thermal conductivity determined by a characteristic value representing thermal conductivity, such as a thermal conductivity rate (the degree of thermal conductivity), or a thermal resistivity that is the reciprocal of thermal conductivity.

To be specific, (i) the first temperature sensor 11 and the second temperature sensor 12 can be provided at positions that are located within the base portion 100 and have heat balance characteristics different from those outside the base portion 100 by installing the first temperature sensor 11 and the second temperature sensor 12 at positions spaced apart from the contact surface F of the base portion 100 and having different thermal conductivity characteristics (hereinafter, this will be referred to as a “first installation condition”). Alternatively, (ii) the first temperature sensor 11 and the second temperature sensor 12 can be provided at positions that are located within the base portion 100 and have heat balance characteristics different from those outside the base portion 100 by installing the first temperature sensor 11 and the second temperature sensor 12 at positions spaced apart from a side surface of the base portion 100 other than the contact surface F and having different thermal conductivity characteristics (hereinafter, this will be referred to as a “second installation condition”). Accordingly, it is preferable to determine the installation positions of the temperature sensors such that either one or both of the first installation condition and the second installation condition are satisfied. This corresponds to a feature that the base portion 100 includes the temperature sensors at (1) positions spaced apart from the contact surface F that is in contact with the skin surface and having different thermal conductivity characteristics, (2) positions spaced apart from a side surface of the base portion 100 other than the contact surface F and having different thermal conductivity characteristics, or positions in which (1) and (2) are combined.

Here are some examples that satisfy the above conditions. For example, as shown in FIG. 2B, installation positions are determined such that a distance (LB) between the contact surface F and the second temperature sensor 12 is smaller than a distance (LA) between the contact surface F and the first temperature sensor 11. In this example, the first temperature sensor 11 and the second temperature sensor 12 are installed in a direction normal to the contact surface F. In this case, the distance between the contact surface F and the installation position of the temperature sensor 11 and the distance between the contact surface F and the installation position of the temperature sensor 12 are different, and thus the heat balance characteristics at the positions of the temperature sensors 11 and 12 are different. Accordingly, a difference (temperature difference) can be produced between the temperatures detected at the two points.

FIG. 2C shows another example. The first temperature sensor 11 is disposed at a center portion in the base portion 100, and the second temperature sensor 12 is disposed near the periphery of the base portion 100. Here, the first temperature sensor 11 and the second temperature sensor 12 are both located a substantially equal distance from the contact surface F. In this case, the first temperature sensor 11 is located at a position spaced apart from the closest one (the one on the top side in the diagram) of the side surfaces of the base portion 100 other than the contact surface F by a distance L1. The second temperature sensor 12 is located at a position spaced apart from the closest one (the one on the right side in the diagram) of the side surfaces of the base portion 100 other than the contact surface F by a distance L2. The distances L1 and L2 satisfy L2<L1. In this case, the heat balance characteristics at the positions of the temperature sensors 11 and 12 are different, and thus a difference can be produced between the temperatures detected at the two points.

It is also possible to use an arrangement as shown in FIG. 2C in which the examples of FIG. 2B and FIG. 2C are combined.

1-3. Configuration Examples of Base Portion

FIGS. 3A to 3D schematically show a few configurations of the base portion 100 in cross section.

FIG. 3A is a diagram showing a schematic configuration of a base portion 100A, as an example of the simplest configuration of the base portion 100. The base portion 100A shown in FIG. 3A includes a substrate such as silicone rubber, and a first temperature sensor 11 and a second temperature sensor 12 that are installed at different positions in the substrate. The determination of the installation positions of the temperature sensors is as described above with reference to FIGS. 2A to 2D, and the same applies to FIGS. 3B to 3D.

FIG. 3B is a diagram showing a schematic configuration of a base portion 100B. The base portion 100B includes an exterior member 20A and an internal space 20B provided in the box-shaped frame portion (case) 20A made of, for example, a resin or metal. A first temperature sensor 11 and a second temperature sensor 12 are fixed with string members within the internal space 20B, and a predetermined gas is contained in the internal space 20B. It can be said that the base portion 100B has a layered structure including the frame member 20A and the internal space 20B.

FIG. 3C is a diagram showing a schematic configuration of a base portion 100C. The base portion 100C is configured by stacking a first layer 30A and a second layer 30B that are made of materials having different thermal conductivities. The materials of the first layer 30A and the second layer 30B can be selected as appropriate from materials having different thermal conductivities. Also, a first temperature sensor 11 is installed in the first layer 30A, and a second temperature sensor 12 is installed in the second layer 30B.

FIG. 3D is a diagram showing a schematic configuration of a base portion 100D. The base portion 100D is configured by stacking a first layer 40A, a second layer 40B, and a circuit board 40C that is fixed to the first layer 40A and includes a first temperature sensor 11 on its upper surface thereof and a second temperature sensor 12 on its lower surface thereof. The circuit board 40C may be further provided with a processor and a memory.

Various configurations of the base portion 100 are shown and illustrated above, but they are merely examples. For example, it is also possible to use configurations obtained by combining the configurations shown in the diagrams. For example, a configuration is possible in which two circuit boards are stacked within a frame member 20A as shown in FIG. 3B, a first temperature sensor 11 is disposed on one of the circuit boards, and a second temperature sensor 12 is disposed on the other circuit board.

1-4. Principles of Temperature Estimation

The surface temperature of the measurement subject can be calculated in accordance with the above-described principles of temperature calculation, but a certain length of time is required until the temperature of the base portion 100 becomes stable and reaches a steady state after the base portion 100 is brought into contact with the measurement subject. During the transition state until the steady state is reached, the first detected temperature Tₐ of the first temperature sensor 11 and the second detected temperature T_{b} of the second temperature sensor 12 fluctuate. Accordingly, if the skin temperature T_{S} is calculated from Equation (14) by using the first detected temperature Tₐ and the second detected temperature T_{b} obtained during the transition state, a wrong temperature may be calculated.

To address this, a technique is introduced for estimating the temperature in the steady state from the temperature of the transition state. To be specific, the present embodiment uses an unsteady-state heat conduction equation obtained from a heat conduction equation. A steady-state skin temperature T_{SX} can be estimated by the following Equation (17), where as temperatures calculated at a time interval, the skin temperature T_{S} calculated at time t₁ is defined as a first skin temperature T_{S1}, and the skin temperature Tₛ calculated at time t₂ is defined as a second skin temperature T_{S2}. In this way, the temperature estimation is performed.

$$\begin{matrix}[ Math 1 ] & \\ {T}_{SX} = \frac{{T}_{S 2} - {T}_{S 1} \times exp ( - \frac{{t}_{2} - {t}_{1}}{R \times C} )}{1 - exp ( - \frac{{t}_{2} - {t}_{1}}{R \times C} )} & ( 17 )\end{matrix}$$

In the above equation, R is a thermal resistance constant, and C is a heat capacity constant, which are pre-set. Each of the thermal resistance constant R and the heat capacity constant C may be pre-set, or the value of R×C may be pre-set. To be specific, initial settings as follows may be used. For example, a skin temperature measured by another arbitrary method is defined as the steady-state skin temperature T_{SX}, and skin temperatures Tₛ calculated by Equation (14) given above by using the first detected temperature Tₐ and the second detected temperature T_{b} detected at different timings during the transition state (unsteady state) are defined as the first skin temperature T_{S1} and the second skin temperature T_{S2}, and then, Equation (17) is back-calculated to obtain the value of R×C, which is used as the value of R×C for use in the temperature estimation.

If the value of R×C can be treated as a constant value regardless of the subject, the value may be set as a default value. In this case, if it is better to change the value of R×C depending on the part used for measurement, a default value appropriate to the part used for measurement may be selected and set.

Also, with the temperature estimation, the temperature can be effectively obtained not only in the transition state (unsteady state) but also in the steady state. Accordingly, in the present embodiment, the temperature obtained by performing processing up to the temperature estimation is constantly output as the surface temperature (output value) of the measurement subject. However, if a predetermined stabilization condition in which the temperature obtained through the temperature calculation does not much change is satisfied, the temperature estimation processing may be omitted, and the temperature obtained through the temperature calculation may be output as the output value.

1-5. Experimental Result

FIG. 4 is a diagram showing an example of a result obtained from an experiment performed to demonstrate the above-described principles. An unsophisticated human body tissue model made by covering an aluminum block with poly(vinyl chloride) at a predetermined thickness was used as the measurement subject. The human body tissue model was placed in a constant temperature water bath containing water in an amount adjusted such that most part of the human body tissue model was submerged in water, and only the upper surface layer portion of the human body tissue model was located above water. Also, the base portion 100 was set such that the contact surface F was in contact with the surface of the portion located above water. The water temperature was 37 degrees.

In this experiment, first, the constant temperature water bath in which the human body tissue model was placed was allowed to stand at a constant atmospheric temperature of 25 degrees for a length of time sufficient for the temperatures of the human body tissue model and the base portion 100 to reach a steady state. After that, the constant temperature water bath in which the human body tissue model was placed was transported to a constant temperature bath maintained at an atmospheric temperature of 0 degrees. FIG. 4 shows temperatures obtained through temperature calculation and temperature estimation performed in accordance with the above-described principles before and after the transportation.

In FIG. 4, the solid line indicates the actual value, the dashed dotted line indicates the temperature (calculated temperature) calculated by using Equation (14), and the broken line indicates the temperature (estimated temperature) estimated by using Equation (17). In the graph shown in FIG. 4, the actual value that was initially about 32.5 degrees started decreasing at the time when the constant temperature water bath was transported, or in other words, the time when the atmospheric temperature was changed. Although not shown in FIG. 4, both the calculated temperature and the estimated temperature finally reached a steady state, from which it was confirmed that both the temperature calculation using Equation (14) and the temperature estimation using Equation (17) provided correct temperatures. However, as can be seen from FIG. 4, the estimated temperature becomes stable earlier than the calculated temperature, from which it can be seen that the temperature in the steady state is obtained at an early stage. Also, during the transition state before the steady state is reached, the changes of the estimated temperature follow the changes of the actual value with good responsivity, and thus it can be said that even during the transition state, it is possible to obtain a more certain temperature that is closer to the actual value than the calculated temperature is.

From the experimental result, the effectiveness of the temperature measurement method of the present embodiment was verified.

### 2. Examples

Next is a description of an example of a temperature measurement device 1 for measuring the surface temperature of a measurement subject in accordance with the above-described principles. In this example, a human body is used as the measurement subject, and the skin temperature (the temperature at a measurement area) is measured by bringing the base portion 100 into contact with the skin surface of a wrist. The part to be contacted is not limited to the wrists, and can be the surface (skin surface) of any body part such as four limbs including the upper arms, the lower arms, the thighs, and the ankles, as well as the head, the neck, and the torso.

2-1. Functional Configuration

FIG. 5 is a block diagram showing an example of a schematic configuration of the temperature measurement device 1 according to the present embodiment. The temperature measurement device 1 includes a base portion 100, and a main body processing block 200. Although not shown, if a battery is provided in the temperature measurement device 1, the temperature measurement device 1 can be made portable and highly convenient. The theoretical configuration of the base portion 100 has already been described above.

The base portion 100 and the main body processing block 200 may be configured as a single unit or may be configured as separate units. In the case where they are configured as separate units, the base portion 100 is configured as, for example, a probe. In this case, the entire shape of the base portion 100 may be planar (for example, button-shaped or sheet-shaped). Alternatively, the base portion 100 may have a cylindrical shape that can be held with one hand. Also, the base portion 100 and the main body processing block 200 may be wire-connected with a cable. Alternatively, the base portion 100 and the main body processing block 200 may be wirelessly connected by providing a compact radio within the base portion 100. The base portion 100 may be provided with a belt or a replaceable adhesive tape so that the base portion 100 can be fixed to any one of four limbs (including the wrists and the ankles), the torso and the neck.

In the case where the base portion 100 and the main body processing block 200 are configured as a single unit, it is preferable to provide, for example, a belt so that it can be fixed to any one of four limbs (including the wrists and the ankles), the torso and the neck. In this case, the casing of the temperature measurement device 1 may be configured, for example, as shown in FIG. 3D, as with the base portion 100. To be specific, a plastic or metal case is used as the frame of the temperature measurement device 1, and a substrate for operating and controlling the constituent elements of the main body processing block 200 is fixedly disposed within the case. Then, a first temperature sensor 11 and a second temperature sensor 12 are mounted on the substrate. Of course, the substrate on which the first temperature sensor 11 and the second temperature sensor 12 are mounted may be provided separately, or a substrate on which the first temperature sensor 11 is mounted and a substrate on which the second temperature sensor 12 is mounted may be individually provided.

The main body processing block 200 includes, for example, a computation processing unit 300, an operation unit 400, a display unit 500, an audio output unit 600, a communication unit 700, and a storage unit 800.

The computation processing unit 300 is a control and computation device that performs overall control on the constituent elements of the temperature measurement device 1 in accordance with various types of programs stored in the storage unit 800, such as a system program. The computation processing unit 300 includes, for example, a processor such as a central processing unit (CPU) or a digital signal processor (DSP).

The computation processing unit 300 includes, as primary functional units, a temperature calculation unit 320 and a temperature estimation unit 340 that are provided to continuously measure the temperature of the measurement subject. The computation processing unit 300 executes temperature measurement processing, which will be described later with reference to FIG. 7, in accordance with a temperature measurement program 810. The computation processing unit 300 also has a clock function for timing a time, and the like.

The temperature calculation unit 320 calculates a temperature according to Equation (14) by using a heat balance relative coefficient 840 that is pre-set in the initial settings, and the detected temperatures indicated by temperature detection signals sent from the first temperature sensor 11 and the second temperature sensor 12.

The temperature estimation unit 340 estimates a temperature according to Equation (17) by using the calculated temperatures calculated by the temperature calculation unit 320 at different timings, or in other words, the previous measurement timing and the current measurement timing. The thermal resistance constant R and the heat capacity constant C, or the value of R×C (hereinafter, referred to collectively as an “estimation constant”) is initialized, and set as an estimation constant 850 in the storage unit 800.

In this example, it is assumed that the temperature estimation unit 340 is constantly working during temperature measurement. Accordingly, a temperature estimated by the temperature estimation unit 340 is stored in the temperature data 830 (see FIG. 6) of the storage unit 800, as an output temperature that is a result of measurement.

The operation unit 400 is an input device having a switch and the like, and outputs a signal of the switch that has been pressed to the computation processing unit 300. The operation unit 400 is used to input values for initial settings and various instructions such as starting and stopping temperature measurement.

The display unit 500 is a display device that has a liquid crystal display (LCD) or the like, and displays various types of information based on a display signal input from the computation processing unit 300. The output temperature that is a result of measurement, the measurement state such as the unsteady state or the steady state, whether the measured temperature is normal or not, and the like are displayed on the display unit 500.

The audio output unit 600 includes a speaker, and reproduces and outputs audio based on an audio signal input from the computation processing unit 300. The audio output unit 600 outputs a notification sound indicating whether the measured temperature is normal or not, and various types of annunciation sounds. The audio as used herein, of course, includes voice.

The communication unit 700 is a communication device for transmitting and receiving information used within the device to and from an external information processing device such as a personal computer (PC) under control of the computation processing unit 300. As the communication method of the communication unit 700, various types of methods can be used such as a method for establishing a wired connection via a cable according to a predetermined communication standard, and a method for establishing a wireless connection by using near-field communication.

The storage unit 800 includes storage devices such as a read-only memory (ROM), a flash ROM, and a random-access memory (RAM). The storage unit 800 stores therein the system program of the temperature measurement device 1, various types of data and programs for implementing a temperature calculation function, a temperature estimation function and a communication function.

The storage unit 800 stores therein, as a program, the temperature measurement program 810 that is read out and executed as temperature measurement processing (see FIG. 7) by the processing unit 300. The temperature measurement program 810 includes, as sub-routines, a temperature calculation program 812 for calculating a temperature in accordance with the above-described principles, and a temperature estimation program 814 for estimating a temperature. The temperature measurement processing will be described later in detail with reference to a flowchart.

The storage unit 800 stores therein, as data, temperature data 830, a heat balance relative coefficient 840, an estimation constant 850, an anomalous temperature condition 870, a normal-state restoration condition 880, and a measurement time interval 890.

The temperature data 830 has, for example, a data structure shown in FIG. 6. Specifically, the detected temperatures obtained based on the temperature detection signals input from the first temperature sensor 11 and the second temperature sensor 12, the calculated temperatures calculated by using the detected temperatures, the output temperatures (output values) estimated by using the calculated temperatures and output as results of measurement, the measurement states indicating whether the measurement state is in the unsteady state or the steady state, and the determined results indicating whether the output temperature is normal or not are stored in association with the time when each measurement was taken. Accordingly, the temperature data 830 may also be referred to as the history data of the respective values. As used herein, the time refers to the time (timing) when a temperature measurement was taken. Also, the measurement state is determined based on the changes in the calculated temperature over time. For example, the rate of temperature change is determined from the difference between two calculated temperatures and the time interval for the calculation, and if the rate of temperature change is within a predetermined range of values, it is determined that the measurement state is in the steady state. Otherwise, it is determined that the measurement state is in the unsteady state.

The heat balance relative coefficient 840 is the value of the aforementioned heat balance relative coefficient D. The heat balance relative coefficient 840 is set when initial settings are made. The estimation constant 850 is the aforementioned thermal resistance constant R and heat capacity constant C, or the value of R×C. This value is also set when initial settings are made.

The anomalous temperature condition 870 is a condition for determining that the output temperature is not normal (anomalous). The anomalous temperature condition 870 is, for example, a condition having an upper limit temperature (for example, 38 degrees or more) and a lower limit temperature (for example, 27 degrees or less) with OR condition. The output temperature is determined as anomalous when it is too high or too low.

The normal-state restoration condition 880 is a condition for determining that the output temperature has returned to a normal temperature after the anomalous temperature condition 870 is satisfied and it is determined that the output temperature is anomalous. The normal-state restoration condition 880 includes a temperature condition (restoration temperature condition) and a time condition (restoration time condition). The restoration temperature condition includes a threshold value that is closer to the normal value than the threshold value of the anomalous temperature condition 870 is. For example, a temperature range having an upper limit temperature of 37.5 degrees and a lower limit temperature of 30 degrees is defined as the restoration temperature condition. The restoration time condition is a condition for determining that a state in which the restoration temperature condition is satisfied has continued for a predetermined length of time. For example, as the restoration time condition, one minute or more is set. The normal-state restoration condition 880 is satisfied when a state in which the restoration temperature condition is satisfied has continued for a length of time that satisfies the restoration time condition.

The measurement time interval 890 is a time interval at which a temperature measurement is performed. The measurement time interval 890 is changed depending on whether the measurement state is in the steady state or the unsteady state (transition state), or depending on whether the output temperature is determined as normal (normal temperature) or not (anomalous temperature). To be specific, if the measurement state is in the unsteady state, the measurement time interval 890 is set to be shorter than when the measurement state is in the steady state. If the output temperature is determined as anomalous, the measurement time interval 890 is set to be shorter than when the output temperature is determined as normal.

The setting of the measurement time interval 890 is not limited thereto. If a state in which the output temperature is determined as normal or the measurement state is in the steady state continues, the measurement time interval 890 may be gradually increased up to a predetermined maximum time interval. Alternatively, if the determined result of the output temperature varies from normal to anomalous, the measurement time interval 890 may be switched to a predetermined minimum time interval, and if the determined result remains anomalous, the measurement time interval 890 may be gradually increase up to a predetermined anomalous time interval. Also, a configuration is possible in which the measurement time interval is set to a minimum time interval at the start of measurement, and during the unsteady state, the measurement time interval is gradually increased according to the length of time during which an unsteady state continues, up to a predetermined unsteady state regular time interval. Increasing the time interval results in less power consumption.

2-2. Procedure of Temperature Measurement Processing

FIG. 7 is a flowchart illustrating a procedure of temperature measurement processing executed by the computation processing unit 300 in accordance with the temperature measurement program 810 stored in the storage unit 800.

First, the computation processing unit 300 makes initial settings (step A1). Here, a heat balance relative coefficient 840 is set. The value of the heat balance relative coefficient 840 may be set through an input operation of the operation unit 400. Alternatively, it is also possible to set a heat balance relative coefficient 840 determined by the computation processing unit 300 by using input of a correct temperature at the measurement area measured with another temperature measurement device and the detected temperatures obtained from the first temperature sensor 11 and the second temperature sensor 12. In the case of the latter, the heat balance relative coefficient 840 can be calculated according to Equation (16) given above.

An estimation constant 850 is also set when the initial settings are made.

Next, the temperature calculation unit 320 receives input of temperature detection signals from the base portion 100 so as to acquire the detected temperature of each temperature sensor, and stores the detected temperatures in the storage unit 800. At the same time, the temperature calculation unit 320 calculates the temperature at the measurement area by using the acquired detected temperatures and the heat balance relative coefficient 840 (step A3). The temperature estimation unit 340 estimates the temperature at the measurement area by using the calculated temperature calculated by the temperature calculation unit 320 at the previous measurement timing and the calculated temperature calculated by the temperature calculation unit 320 at the current measurement timing (step A3). The resulting estimated temperature is determined as a result of measurement performed at the current measurement timing, and then stored in the storage unit 800 as the output temperature. The calculated temperature obtained during the process of obtaining the output temperature is also stored in the storage unit 800 in association with the time when the measurement was taken.

Next, the computation processing unit 300 determines the measurement state based on the changes in the calculated temperature over time, and stores the determined measurement state in the storage unit 800 (step A4). Then, the output temperature is displayed on the display unit 500 (step A5). At this time, the determined measurement state may be displayed.

If the output temperature satisfies the anomalous temperature condition 870 (YES in step A7), the computation processing unit 300 determines that the output temperature is anomalous, and then issues a notification indicating that the output temperature is anomalous (step A9). If the output temperature does not satisfy the anomalous temperature condition 870 (NO in step A7), the computation processing unit 300 determines whether or not the result of measurement performed at the previous measurement timing indicates that the output temperature was anomalous (step A11). If an affirmative determination is made (YES in step A11), the computation processing unit 300 determines whether or not the current output temperature satisfies the restoration temperature condition of the normal-state restoration condition 880 (step A13). If a negative determination is made (NO in step A13), the output temperature is determined as anomalous (step A9). In this case, although the current output temperature is not anomalous, because the previously determined result indicates that the output temperature was anomalous, the output temperature is continuously determined as anomalous until it is determined that the output temperature is not anomalous.

If it is determined that the restoration temperature condition is satisfied, (YES in step A13), the length of time during which it is determined that the restoration temperature condition is satisfied is timed (steps A15 to A17). That is, if the length of time is not being timed, the elapsed time is reset and timing of the length of time is started.

If the elapsed time satisfies the restoration time condition (YES in step A19), the timing of the elapsed time is stopped (step A21), and it is determined that the output temperature has returned to a normal temperature, and thereafter that fact is notified (step A23). If the elapsed time does not satisfy the restoration time condition (NO in step A19), the output temperature is continuously determined as anomalous (step A9), and the output temperature is continuously monitored.

If it is determined in step A11 that the result of measurement performed at the previous measurement timing indicates that the output temperature was not anomalous (NO in step A11), the output temperature is determined as normal, and that fact is notified (step A25).

After any one of steps A9, A23 and A25, the computation processing unit 300 sets a measurement time interval 890. To be specific, in the case where the measurement state is in the unsteady state (Unsteady state in step A27), a time interval Iₜ₁ is set as the measurement time interval 890 (step A31). In the case where the measurement state is in the steady state (Steady state in step A27), a time interval Iₜ₂ is set as the measurement time interval 890 if the output temperature is determined as anomalous, and a time interval Iₜ₃ is set as the measurement time interval 890 if the output temperature is determined as normal (steps A33 and A35). The time interval satisfies Iₜ₁<Iₜ₂<Iₜ₃.

Then, if the computation processing unit 300 determines, based on the set measurement time interval 890, that the next measurement timing has been reached, the procedure proceeds to step A3. If the computation processing unit 300 determines that the temperature measurement has finished, the temperature measurement processing ends (step A37).

2-3. Advantageous Effects

With the temperature measurement device 1, it is possible to calculate the surface temperature of the measurement subject by using temperatures detected by a plurality of temperature sensors provided at different positions in the base portion 100.

Also, the temperature sensors 11 and 12 are provided at positions that are located within the base portion 100 and have heat balance characteristics different from those outside the base portion 100. In terms of the physical structure of the base portion 100, the base portion 100 includes the temperature sensors 11 and 12 at (1) positions spaced apart from the contact surface F that is in contact with the measurement subject and having different thermal conductivity characteristics, (2) positions spaced apart from a side surface of the base portion 100 other than the contact surface F and having different thermal conductivity characteristics, or positions in which (1) and (2) are combined. This configuration causes heat balance characteristics to be different at the positions of the temperature sensors 11 and 12 and produces a difference (temperature difference) between the temperatures detected by the temperature sensors 11 and 12. The relative relationship of heat balance characteristics at the positions of the temperature sensors 11 and 12 is more clearly reflected to the heat balance relative coefficient D as the temperature difference becomes larger. As a result, the surface temperature of the measurement subject can be measured with high accuracy.

Also, when measuring the temperature, in consideration of the unsteady state (transition state) in which the temperature of the base portion 100 has not reached the steady state, the temperature in the steady state is estimated from a temporarily calculated temperature. By doing so, a highly accurate temperature can be obtained even in the unsteady state (transition state), which is immediately after the base portion 100 is brought into contact with the skin surface.

### 3. Variations

It is needless to say that examples to which the invention is applicable are not limited to those given above, and the invention can be changed as appropriate without departing from the spirit and scope of the invention. Hereinafter, variations will be described. In the variations, constituent elements that are the same as those of the above embodiment and steps that are the same as those of the flowchart described above are given the same reference numerals, and redundant descriptions thereof are omitted.

3-1. Number of Temperature Sensors Installed

In the above embodiment, an example is described in which two temperature sensors are installed within the base portion 100, but three or more temperature sensors may be installed at different positions within the base portion 100. In this case, as the heat flow path model described in FIGS. 1A to 1C, a number of heat flow paths corresponding to the number of temperature sensors installed may be modeled in the same manner as the above-described embodiment.

To be specific, in the case where n temperature sensors are installed in the base portion 100 (where n 2), for each of the first to nth heat flow paths, a heat flow path model, which is similar to that shown in FIG. 1C, is constructed. Then, the temperature equation in each of the first to nth detection positions is formulated. Then, the relative relationship of heat balance characteristics at each of the first to nth detection positions is defined as the heat balance relative coefficient. After that, the surface temperature is measured in the same manner as in the embodiment described above.

3-2. Selection of Temperature Sensors

A configuration is also possible in which three or more temperature sensors are installed at different positions in the base portion 100, and the surface temperature of the measurement subject is measured by selecting at least two temperature sensors from among the installed temperature sensors. In the case where, for example, three temperature sensors are installed, two temperature sensors are selected from among the three temperature sensors so as to perform temperature measurement. In the case where, for example, four temperature sensors are installed, two or three temperature sensors may be selected from among the four temperature sensors so as to perform temperature measurement. Here, as an example, the case where three temperature sensors are installed in the base portion 100 will be described.

FIG. 8A is a diagram showing an example of a schematic configuration of a base portion 100G according to the present variation. The base portion 100G includes a first temperature sensor 11, a second temperature sensor 12, and a third temperature sensor 13 that are respectively provided at a first detection position P₁, a second detection position P₂, and a third detection position P₃.

FIG. 8B is a diagram showing a functional configuration of a computation processing unit 300 according to the present variation. The computation processing unit 300 further includes a temperature sensor selecting unit 313. The temperature sensor selecting unit 313 is a selecting unit that selects two temperature sensors from among the three temperature sensors.

FIG. 9 is a flowchart illustrating additional processing performed immediately before step A3 of the temperature measurement processing shown in FIG. 7, the additional processing executed by the computation processing unit 300 shown in FIG. 8B according to the present variation.

After the processing of step A1 or step A29, the computation processing unit 300 acquires temperatures detected by the first to third temperature sensors 11 to 13 (step B3). Then, for each combination of two temperature sensors, the difference between detected temperatures (hereinafter referred to as a “detected temperature difference”) is calculated (step B5).

Next, the temperature sensor selecting unit 313 determines temperature sensors used to perform temperature measurement (hereinafter referred to as a “temperature sensor used for measurement”) based on the detected temperature differences calculated in step B5 (step B7). To be specific, for example, a combination of temperature sensors whose detected temperature difference is greatest is determined, and the two temperature sensors included in the combination are selected as the temperature sensors used for measurement.

In step A3 following the above-described step, temperature calculation is performed by using the heat balance relative coefficient D corresponding to the combination of temperature sensors used for measurement selected in step B7.

3-3. Heat Balance Relative Coefficient and Arithmetic Equation for Surface Temperature

The heat balance relative coefficients and the arithmetic equations for surface temperature described in the above embodiment are merely given as examples, and thus the invention is not limited thereto.

3-4. Output Temperature

In the above embodiment, the temperature estimation is constantly performed, and the estimated temperature is output as the output temperature. However, in the case of the steady state, the calculated temperature obtained through the temperature calculation may be output as the output temperature. This can be achieved by replacing, for example, the processing of step A3 of the temperature measurement processing shown in FIG. 7 by the processing shown in FIG. 10. To be specific, after the temperature calculation (step C31), it is determined based on the transition of the calculated temperature stored in the temperature data 830, whether or not the change in the calculated temperature is within a predetermined range indicating the steady state, based on which it is determined whether the measurement state is in the steady state or the unsteady state (step C33). The determination as to whether the measurement state is in the steady state or the unsteady state may be made based on the difference between the calculated temperature obtained in the previous measurement timing and the calculated temperature obtained in the current measurement timing, or may be determined based on the difference between the maximum value and the minimum value of the calculated temperatures obtained from several instances of measurement (for example, five instances of measurement). Then, if it is determined that the measurement state is in the steady state, the calculated temperature is output as the output temperature without performing the temperature estimation (step C39). If, on the other hand, it is determined that the measurement state is in the unsteady state, the temperature estimation is performed (step C35), and the estimated temperature is output as the output temperature (step C37).

3-5. Temperature Calculation and Temperature Estimation

In the embodiment described above, the temperature estimation is performed by using a calculated temperature obtained through the temperature calculation using a first detected temperature Tₐ and a second detected temperature T_{b}, but the following configuration is also possible. Specifically, the order of the temperature calculation and the temperature estimation is reversed. A temperature is estimated from Equation (17) by using, instead of the first skin temperature T_{S1} calculated at time t₁ and the second skin temperature T_{S2} calculated at time t₂, a first detected temperature Tₐ1 detected at time t₁ and a first detected temperature Tₐ2 detected at time t₂. This estimated temperature is defined as a temperature Tₐ′. Likewise, a temperature is estimated from Equation (17) by using, a second detected temperature T_{b1} detected at time t₁ and a second detected temperature T_{b2} detected at time t₂. This estimated temperature is defined as a temperature T_{b}′. Then, a temperature is calculated from Equation (14) by using, instead of Tₐ and T_{b} in Equation (14), the temperature Tₐ′ and the temperature T_{b}′. The calculated temperature is output as the output temperature. The method in which the order of the temperature calculation and the temperature estimation is reversed is suitably used in the unsteady state (transition state).

3-6. Measurement Area

In the above embodiment, the skin is used as the measurement area, and the surface temperature of the measurement subject is measured. However, as can be seen from the heat flow path models shown in FIGS. 1B and 1C, the measurement area does not necessarily need to be the surface of the measurement subject. For example, the measurement area may be a specific area at a position located from the surface by a predetermined depth (for example, the position of a specific internal organ or a specific biological tissue), and the temperature of that position may be measured (calculated or estimated). In this case, the embodiment can be implemented by reading the embodiment given above by replacing the words “surface temperature” and “skin temperature” written in the description of the embodiment given above by “temperature at the measurement area”. Of course, in this case, values corresponding to the measurement area are used as the heat balance relative coefficient D, the thermal resistance constant R, the heat capacity constant C, and the value of R×C.

The entire disclosure of Japanese Patent Application No. 2013-048829, filed Mar. 12, 2013 is expressly incorporated by reference herein.

What is claimed is:

1. A temperature measurement device comprising:
at least two temperature sensors provided at different positions in a base portion that is in contact with a measurement subject; and
a computation processing unit configured to calculate a temperature of the measurement subject by using temperatures detected by the at least two temperature sensors.

2. The temperature measurement device according to claim 1,
wherein the computation processing unit calculates the temperature of the measurement subject by using relative relationship data and the temperatures detected by the at least two temperature sensors, the relative relationship data representing a relative relationship of heat balance at positions of the at least two temperature sensors when the base portion is in contact with the measurement subject.

3. The temperature measurement device according to claim 2,
wherein the at least two temperature sensors are provided at positions that are located within the base portion and have a heat balance different from a heat balance outside the base portion.

4. The temperature measurement device according to claim 1,
wherein the base portion includes the at least two temperature sensors at (1) positions spaced apart from a contact surface that is in contact with the measurement subject and having different thermal conductivities, (2) positions spaced apart from a surface other than the contact surface and having different thermal conductivities, or positions in which (1) and (2) are combined.

5. The temperature measurement device according to claim 1,
wherein the base portion includes a plurality of layers having different thermal conductivities, and includes the at least two temperature sensors in the layers having different thermal conductivities.

6. The temperature measurement device according to claim 2,
wherein the base portion includes three or more of the temperature sensors at different positions, and
the computation processing unit selects at least two temperature sensors from among the temperature sensors provided in the base portion, and calculates the temperature of the measurement subject by using the relative relationship data of a combination of selected temperature sensors and temperatures detected by the selected temperature sensors.

7. The temperature measurement device according to claim 1,
wherein the computation processing unit calculates the temperature of the measurement subject in a steady state based on a plurality of temperatures obtained by performing the calculation at different calculation timings.

8. The temperature measurement device according to claim 7,
wherein the computation processing unit outputs, as an output value, the temperature obtained by the calculation when a temperature of the base portion is in an unsteady state.

9. The temperature measurement device according to claim 7,
wherein the computation processing unit outputs, as an output value, the temperature obtained by the calculation when a temperature of the base portion is in a steady state.

10. The temperature measurement device according to claim 1,
wherein the computation processing unit estimates a detected temperature in a steady state based on the detected temperatures at different calculation timings, and calculates the temperature of the measurement subject by using the estimated detected temperature.

11. The temperature measurement device according to claim 1,
wherein the computation processing unit changes a time interval for performing the calculation depending on whether a temperature of the base portion is in a steady state or an unsteady state.

12. A temperature measurement method for a temperature measurement device including at least two temperature sensors provided at different positions in a base portion that is in contact with a measurement subject, and a computation processing unit, the temperature measurement method comprising:
detecting temperatures by using the at least two temperature sensors; and
calculating a temperature of the measurement subject by using the temperatures detected by the at least two temperature sensors.

13. The temperature measurement method according to claim 12, further comprising calculating the temperature of the measurement subject in a steady state based on a plurality of temperatures obtained by performing the calculation at different calculation timings.

14. The temperature measurement method according to claim 13, further comprising outputting, as an output value, the temperature obtained by the calculation when a temperature of the base portion is in an unsteady state.

15. The temperature measurement method according to claim 13, further comprising outputting, as an output value, the temperature obtained by the calculation when a temperature of the base portion is in a steady state.
